(19) United States
(12) Patent Application Publication
(10) Pub. No.: US 2025/0279444 A1
(43) Pub. Date: Sep. 4, 2025

(54) COOLING SYSTEM FOR FUEL CELL ONBOARD A VEHICLE INCLUDING EVAPORATIVE COOLING DEVICE

(71) Applicant: ZeroAvia Ltd., Kemble (GB)

(72) Inventors: Seied Masoud Ameli, Swindon (GB); Michael Patterson, Bath (GB); Matthew Graham Legg, Swindon (GB); Christian Bailey, Palo Alto, CA (US)

(73) Assignee: ZeroAvia Ltd., Kemble (GB)

(21) Appl. No.: 18/859,135

(22) PCT Filed: Apr. 29, 2022
(86) PCT No.: PCT/GB2022/051114

§ 371 Date: Oct. 22, 2024

(51) Int. Cl. H01M 8/04007; H01M 8/0432; H01M 8/04746

(52) U.S. Cl. CPC H01M 8/04059; H01M 8/04358; H01M 8/04768; H01M 2250/20

(57) ABSTRACT

A cooling system for a fuel cell onboard a vehicle includes a coolant circuit and an evaporative cooling device including an evaporation chamber and a thermally conductive conduit extending through the evaporation chamber. The coolant circuit is configured to circulate a coolant through the coolant circuit and through a portion of the fuel cell. The thermally conductive conduit has an inner surface that at least partially defines a coolant channel in fluid communication with the coolant circuit and an opposite outer surface exposed to an environment within the evaporation chamber. When a working fluid is applied to the outer surface of the thermally conductive conduit within the evaporation chamber. the evaporative cooling device is configured to evaporatively cool the coolant flowing through the coolant channel by promoting evaporation of the working fluid from the outer surface of the thermally conductive conduit.

### FIELD

The present disclosure relates to cooling systems for fuel cells onboard vehicles and, more particularly, to cooling systems for fuel cells that include evaporative cooling devices.

### BACKGROUND AND SUMMARY

This section provides background information related to the present disclosure which is not necessarily prior art. This section provides a general summary of the disclosure and is not a comprehensive disclosure of its full scope or all of its features.

A fuel cell is an electrochemical cell that converts chemical energy into electrical energy by means of spontaneous electrochemical reduction-oxidation (redox) reactions. Fuel cells include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Fuel cells may be used as power sources for electric motors of electric vehicles and hybrid electric vehicles, including aircraft. In such applications, fuel cells are oftentimes arranged in stacks of multiple cells and connected in a series or parallel arrangement to achieve a desired power and output voltage. Cooling systems for fuel cell-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle. An airflow generated in this manner is oftentimes referred to as ram air and, when ram air is used as a cooling medium in a vehicle, the vehicle may experience increased drag, which may reduce the energy efficiency of the vehicle.

In fuel cell-powered aircraft, the power output demanded of the fuel cells—and the amount of waste heat generated by the fuel cells—is oftentimes greatest during take-off and climb. Waste heat generated during operation of powered aircraft may be dissipated by positioning an air-cooled heat exchanger in an ambient airflow path through the aircraft. Directing ambient air to flow through the aircraft (instead of around the aircraft) when the aircraft is moving creates drag, with the amount of drag experienced by the aircraft being proportional to the volume of ambient air directed through the aircraft (and through the heat exchanger). In practice, the volume of the air-cooled heat exchanger (and the volume of air directed through the heat exchanger) may be selected to accommodate the most demanding cooling requirements of the aircraft, which may occur when the aircraft is operating under high load conditions, e.g., during take-off and climb. However, sizing the heat exchanger in this way may cause the aircraft to experience an unnecessarily large amount of drag when the aircraft is operating under low load conditions, e.g., during cruise, when minimal waste heat dissipation is needed. In addition, when cooling requirements are low, the presence of an oversized heat exchanger onboard the aircraft adds unnecessary weight and bulk to the aircraft.

It may be desirable to develop a system that can be used to effectively remove waste heat from a fuel cell onboard a vehicle during high load events without increasing the amount of drag experienced by the vehicle when the vehicle is operating under normal or low load conditions.

A cooling system for a fuel cell onboard a vehicle is disclosed. The cooling system comprises a coolant circuit and an evaporative cooling device. The coolant circuit defines a coolant passageway and is configured to circulate a coolant through the coolant passageway and through a portion of the fuel cell to absorb heat from the fuel cell. The evaporative cooling device includes an evaporation chamber and a thermally conductive conduit extending through the evaporation chamber. The thermally conductive conduit has an inner surface and an opposite outer surface. The inner surface of the thermally conductive conduit at least partially defines a coolant channel in fluid communication with the coolant circulating through the coolant passageway. The outer surface of the thermally conductive conduit is exposed to an environment within the evaporation chamber. When a working fluid is applied to the outer surface of the thermally conductive conduit within the evaporation chamber, the evaporative cooling device is configured to evaporatively cool the coolant flowing through the coolant channel by promoting evaporation of the working fluid from the outer surface of the thermally conductive conduit.

The evaporation chamber may be defined by a housing including an opening in fluid communication with a circumambient environment. The opening in the housing may be configured to provide an outlet for gases including the working fluid to be discharged from the evaporation chamber.

The opening in the housing may be in fluid communication with a circumambient environment of the vehicle.

The cooling system may further comprise a plenum including an inlet and an outlet in fluid communication with the circumambient environment of the vehicle. The inlet of the plenum may be configured to receive an airflow from the circumambient environment when the vehicle is moving. The opening in the housing may be in fluid communication with the inlet and the outlet of the plenum.

The cooling system may further comprise a vacuum pump and evacuation system configured to generate a subatmospheric pressure environment within the evaporation chamber.

The vacuum pump and evacuation system may be configured to exhaust gases including the working fluid from the evaporation chamber to a circumambient environment of the vehicle.

The cooling system may further comprise a working fluid reservoir in fluid communication with the evaporation chamber of the evaporative cooling device. The working fluid reservoir may include a working fluid.

The cooling system may further comprise a volume of the working fluid contained within the evaporation chamber. In such case, the outer surface of the thermally conductive conduit may be at least partially submerged within the volume of the working fluid contained within the evaporation chamber.

A boiling point of the working fluid may be less than that of the coolant circulating through the coolant passageway of the coolant circuit at the same pressure.

The working fluid may comprise water, ethanol, or a combination thereof.

A vapor pressure of the working fluid may be greater than the vapor pressure of water at the same temperature.

The cooling system may further comprise a bypass operable to direct the coolant circulating through the coolant passageway to enter the evaporative cooling device or to bypass the evaporative cooling device.

The cooling system may further comprise a controller configured to control operation of the bypass such that (i) coolant flows into the evaporative cooling device when the vehicle is operating under high load conditions, and (ii) coolant bypasses the evaporative cooling device when the vehicle is operating under low load conditions.

The cooling system may further comprise a temperature sensor configured to sense a temperature of the coolant flowing through the coolant passageway defined by the coolant circuit and to communicate the temperature to the controller.

The controller may be configured to control operation of the bypass such that (i) coolant flows into the evaporative cooling device when the temperature sensor indicates that the temperature of the coolant flowing through the coolant passageway is greater than a defined value, and (ii) coolant bypasses the evaporative cooling device when the temperature sensor indicates that the temperature of the coolant flowing through the coolant passageway is less than the defined value.

The cooling system may further comprise a nozzle configured to apply droplets of a working fluid onto the outer surface of the thermally conductive conduit.

The cooling system may further comprise a plenum including an inlet and an outlet in fluid communication with a circumambient environment. The inlet may be configured to receive an airflow from the circumambient environment.

The cooling system may further comprise a heat exchanger in fluid communication with the inlet and the outlet of the plenum. The heat exchanger may be configured to transfer heat from the coolant circulating through the coolant passageway to the airflow flowing through the plenum.

The heat exchanger may be disposed within the plenum.

The inlet of the plenum may be configured to receive the airflow from the circumambient environment when the vehicle is moving.

The cooling system may further comprise a third heat exchanger coupled to the fuel cell. The third heat exchanger may be configured to transfer heat from the fuel cell to the coolant circulating through the coolant passageway defined by the coolant circuit.

The fuel cell may comprise an anode configured to receive a hydrogen-containing reactant gas and to discharge a hydrogen-containing exhaust gas stream and a cathode configured to receive an oxygen-containing reactant gas and to discharge a water vapor-containing exhaust gas stream.

The cooling system may further comprise a coolant header tank in fluid communication with the coolant passageway defined by the coolant circuit.

The vehicle may be an aircraft.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a process flow diagram of a cooling system for a fuel cell onboard a vehicle, the cooling system comprises a coolant circuit, a plenum in fluid communication with an ambient environment, a liquid-to-air heat exchanger disposed within an ambient airflow path through the plenum, and an evaporative cooling device in fluid communication with the coolant circuit.

FIG. 2 is a schematic depiction of an aircraft including a fuel cell onboard the aircraft.

FIG. 3 is a schematic cross-sectional view of the evaporative cooling device of FIG. 1, the evaporative cooling device including a housing defining an evaporation chamber and a coolant channel extending through the evaporation chamber, the coolant channel being at least partially defined by an inner surface 58 of a thermally conductive conduit.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

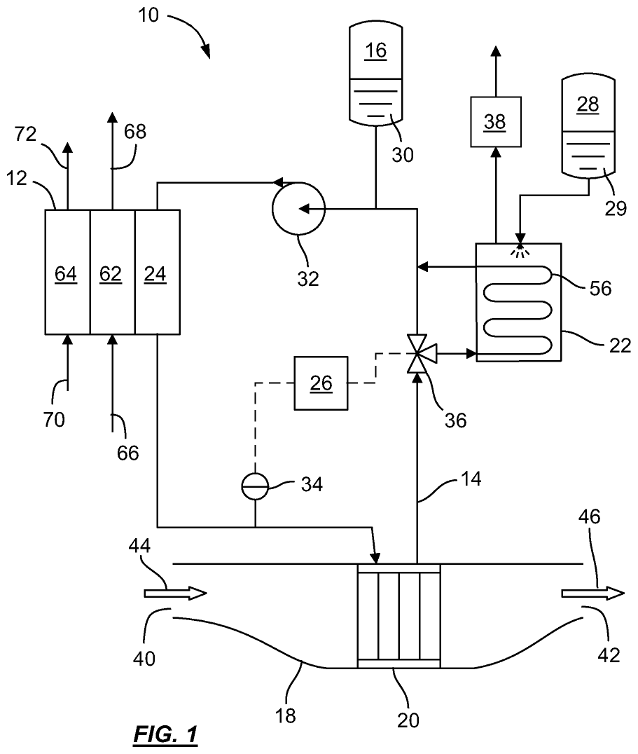

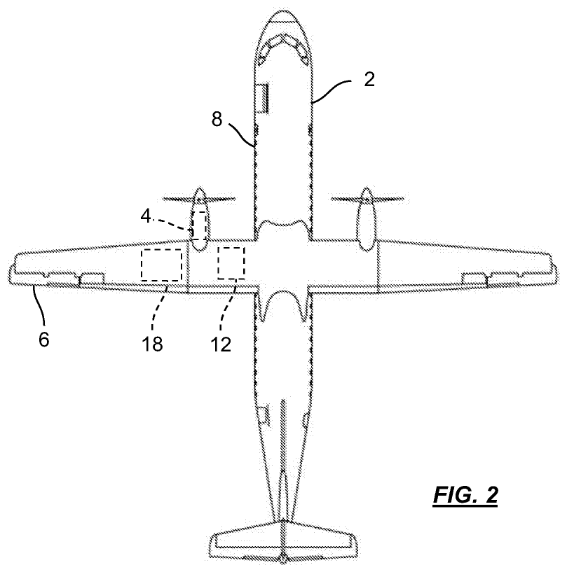

FIG. 1 depicts a process flow diagram of a cooling system 10 for a fuel cell 12 onboard a vehicle. As shown in FIG. 2, the fuel cell 12 may be located onboard an aircraft 2 that is powered at least in part by an electric motor 4. In some embodiments, the fuel cell 12 may be disposed in a wing 6 of the aircraft 2. In some embodiments, the fuel cell 12 may be disposed in a fuselage 8 of the aircraft 2 or in any other part of the aircraft 2.

The cooling system 10 may be configured to maintain the fuel cell 12 within an acceptable operating temperature range, for example, by transferring waste heat generated by the fuel cell 12 away from the fuel cell 12 to a cooling medium. The cooling system 10 may be configured to accommodate varying cooling requirements of the aircraft 2. To accomplish this, for example, the cooling system 10 may vary the amount of heat transferred away from the fuel cell 12, for example, to accommodate situations when the vehicle is operating under normal operating conditions, when the vehicle is operating under low load conditions (e.g., during cruise), or when the vehicle is operating under high load conditions (e.g., during take-off and climb). In some embodiments, when the fuel cell 12 is in the process of warming up to a desired operating temperature, the cooling system 10 may operate without transferring heat away from the fuel cell 12 until the desired operating temperature is reached.

The presently disclosed cooling system 10 will be described more fully hereinbelow with reference to the exemplary embodiment depicted in FIG. 1. The presently disclosed cooling system 10, however, is not limited to the arrangement shown in FIG. 1 and may be embodied in different forms. In addition, in the following description, the cooling system 10 is described with reference to use in an aircraft 2; however, the presently disclosed cooling system 10 is not limited to aircraft and may be used in a variety of different vehicle applications. The scope of the present disclosure is defined by the claims and their equivalents.

The cooling system 10 depicted in FIG. 1 includes a coolant circuit 14, a coolant header tank 16, a plenum 18, a liquid-to-air heat exchanger 20, an evaporative cooling device 22, a fuel cell heat exchanger 24 coupled to the fuel cell 12, a controller 26, and a working fluid reservoir 28 containing a volume of a working fluid 29. In some embodiments, the cooling system 10 may comprise a vacuum pump and evacuation system 38 coupled to the evaporative cooling device 22. The coolant circuit 14 is in fluid communication with the coolant header tank 16 and defines a passageway for circulation of a coolant 30 from the coolant header tank 16, through the coolant circuit 14, and through the fuel cell heat exchanger 24 to transfer waste heat away from the fuel cell 12 to the coolant 30. The coolant 30 is formulated to assist in the transfer of thermal energy between various components of the cooling system 10 and in the discharge of waste heat from the cooling system 10 to an ambient environment. The coolant 30 may comprise a heat transfer fluid having a high specific heat capacity and good thermal, chemical, electrical (e.g., not electrically conductive, dielectric), and mechanical compatibility with the other components of the cooling system 10 and with the fuel cell 12.

In the embodiment depicted in FIG. 1, the coolant circuit 14 includes a coolant pump 32, a temperature sensor 34, and a bypass valve 36. The coolant pump 32 is configured to circulate the coolant 30 through the passageway defined by the coolant circuit 14. The temperature sensor 34 is configured to sense the temperature of the coolant 30 circulating through the coolant passageway of the coolant circuit 14. As shown in FIG. 1, in some embodiments, the temperature sensor 34 may be positioned downstream of the fuel cell heat exchanger 24 and upstream of the liquid-to-air heat exchanger 20 in the passageway defined by the coolant circuit 14. In such an arrangement, the temperature sensor 34 may be configured to sense the temperature of the coolant 30 exiting the fuel cell heat exchanger 24 and to transmit a signal to the controller 26 indicative of the temperature of the coolant 30 at that specific location within the passageway defined by the coolant circuit 14. In some embodiments, a temperature sensor (not shown) may be positioned upstream of the fuel cell heat exchanger 24 and downstream of the coolant header tank 16 and/or the coolant pump 32 in the passageway defined by the coolant circuit 14. In such case, the temperature sensor may be configured to sense the temperature of the coolant 30 prior to entering the fuel cell heat exchanger 24 and may be configured to transmit a signal to the controller 26 indicative of the temperature of the coolant 30 at that specific location within the passageway defined by the coolant circuit 14.

The bypass valve 36 is operable to control the path of the coolant 30 circulating in the passageway defined by the coolant circuit 14. As shown in FIG. 1, the bypass valve 36 may be positioned in the passageway defined by the coolant circuit 14, between the liquid-to-air heat exchanger 20 and the evaporative cooling device 22. In such an arrangement, the bypass valve 36 may be operable to control the flow of the coolant 30 exiting the liquid-to-air heat exchanger 20 so that the coolant 30 is either directed to flow through the evaporative cooling device 22 or is directed to bypass the evaporative cooling device 22.

Operation of the bypass valve 36 may be controlled, for example, by the controller 26. For example, the controller 26 may be configured to control operation of the bypass valve 36 such that (i) coolant 30 flows into the evaporative cooling device 22 when the aircraft 2 is operating under high load conditions (e.g., during take-off and/or climb), and (ii) coolant 30 is prevented from flowing into the evaporative cooling device 22 when the aircraft 2 is operating under low load conditions (e.g., during cruise). In some embodiments, the controller 26 may control operation of the bypass valve 36 based upon information received from the temperature sensor 34. For example, if the temperature sensor 34 indicates that the temperature of the coolant 30 is below a defined temperature limit, the controller 26 may control operation of the bypass valve 36 so that coolant 30 flowing through the passageway defined by the coolant circuit 14 bypasses the evaporative cooling device 22. On the other hand, if the temperature sensor 34 indicates that the temperature of the coolant 30 is above a defined temperature limit, the controller 26 may control operation of the bypass valve 36 so that coolant 30 flows into the evaporative cooling device 22 and provides auxiliary evaporative cooling to the coolant 30 flowing through the coolant channel 56.

In some embodiments, for example, when the fuel cell 12 is in the process of warming up to a desired operating temperature, coolant 30 flowing through the coolant circuit 14 may be directed to bypass the fuel cell heat exchanger 24. In such case, the cooling system 10 may operate without transferring heat away from the fuel cell 12 until the fuel cell 12 reaches a desired operating temperature.

The coolant header tank 16 contains a volume of the coolant 30 and may help accommodate thermal expansion of the coolant 30 and ensure positive pressure is maintained within the coolant circuit 14 during operation of the cooling system 10.

The plenum 18 includes an inlet 40 and an outlet 42 in fluid communication with a circumambient environment of the aircraft 2. The inlet 40 of the plenum 18 is configured to receive an airflow 44 of ambient air from the circumambient environment and the outlet 42 is configured to discharge a processed airflow 46 from the plenum 18, for example, to the circumambient environment. The airflow 44 introduced into the inlet 40 of the plenum 18 may be “ram air” and may be generated when the aircraft 2 is moving. The plenum 18 may be constructed and arranged to direct the airflow 44 through the aircraft 2 and through one or more components disposed within an airflow path through the plenum 18. As shown in FIG. 2, in some embodiments, the plenum 18 may be defined in the wing 6 of the aircraft 2. In some embodiments, the plenum 18 may be defined in the fuselage 8 of the aircraft 2 or in any other part of the aircraft 2, for example, in a nose of the aircraft 2.

The liquid-to-air heat exchanger 20 depicted in FIG. 1 is positioned in the airflow path defined between the inlet 40 and the outlet 42 of the plenum 18 and is configured to promote indirect heat transfer between the coolant 30 and the airflow 44 passing therethrough. The liquid-to-air heat exchanger 20 may include an airflow channel and a coolant channel separated by a thermally conductive impervious barrier (not shown). The airflow channel of the liquid-to-air heat exchanger 20 may be in fluid communication with the inlet 40 and the outlet 42 of the plenum 18, and the coolant channel of the liquid-to-air heat exchanger 20 may be in fluid communication with the coolant 30 circulating through the passageway defined by the coolant circuit 14. In some embodiments, the airflow channel of the liquid-to-air heat exchanger 20 may be in fluid communication with the inlet 40 and the outlet 42 of the plenum 18 but the liquid-to-air heat exchanger 20 may not be disposed directly within the plenum 18. In the liquid-to-air heat exchanger 20, heat may be transferred from the coolant 30 to the barrier disposed between the airflow channel and the coolant channel by convection, heat may be transferred through the barrier by conduction, and heat may be transferred from the barrier to the airflow 44 by convection. Heat may be transferred from the coolant 30 to the airflow 44 within the liquid-to-air heat exchanger 20 to help remove waste heat generated by the fuel cell 12 from the cooling system 10. In some embodiments, the liquid-to-air heat exchanger 20 may be in the form of a double pipe, shell and tube, plate, plate and shell, adiabatic shell, finned tube, or plate and fin heat exchanger. The flow direction of the coolant 30 in the coolant channel may be parallel, opposite, or transverse to the flow direction of the airflow 44 in the airflow channel of the liquid-to-air heat exchanger 20.

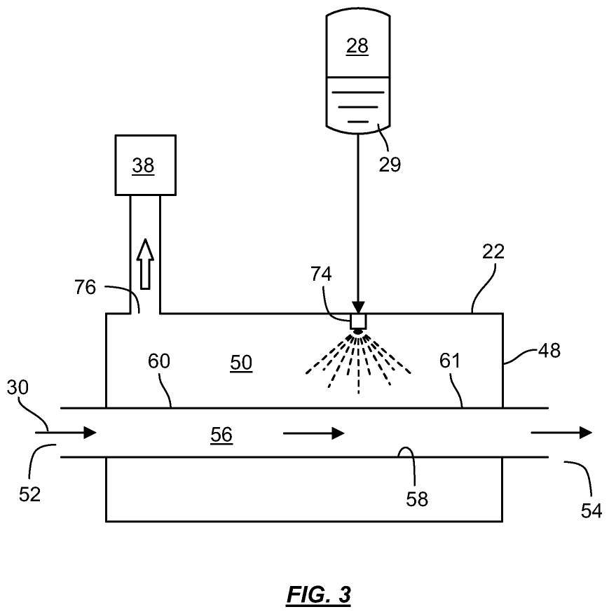

The evaporative cooling device 22 is configured to evaporatively cool the coolant 30 circulating through the passageway defined by the coolant circuit 14. As best shown in FIG. 3, the evaporative cooling device 22 may include a housing 48 defining an evaporation chamber 50 and including a coolant inlet 52, a coolant outlet 54, and a coolant channel 56 extending through the evaporation chamber 50. The coolant inlet 52 and the coolant outlet 54 of the housing 48 are in fluid communication with the coolant 30 circulating through the passageway defined by the coolant circuit 14 and with the coolant channel 56 extending through the evaporation chamber 50. The coolant channel 56 may be at least partially defined within the housing 48 by an inner surface 58 of a thermally conductive conduit 60. An opposite outer surface 61 of the thermally conductive conduit 60 may be exposed to the environment within the evaporation chamber 50. In practice, coolant 30 is introduced into housing 48 and into the coolant channel 56 via the coolant inlet 52, is directed through the coolant channel 56, and exits the housing 48 via the coolant outlet 54. A working fluid 29 may be introduced into the evaporation chamber 50 and applied to the outer surface 61 of the thermally conductive conduit 60, for example, via the working fluid reservoir 28. The thermally conductive conduit 60 provides a thermally conductive pathway for the indirect transfer of thermal energy between the coolant 30 flowing through the coolant channel 56 and the working fluid 29 in direct contact with the outer surface 61 of the thermally conductive conduit 60. The thermally conductive conduit 60 is configured to prevent physical transfer between the coolant 30 flowing through the coolant channel 56 and the working fluid 29 in contact with the outer surface 61 of the thermally conductive conduit 60. As shown in FIG. 3, in some embodiments, the working fluid 29 may be introduced into the evaporative cooling device 22, for example, by being sprayed onto the outer surface 61 of the thermally conductive conduit 60 via a nozzle 74. In some embodiments, at least a portion of the thermally conductive conduit 60 may be submerged within a volume of the working fluid 29 contained in the evaporation chamber 50.

In the embodiment depicted in FIG. 1, the coolant channel 56 follows a serpentine path through the evaporative cooling device 22. In the embodiment depicted in FIG. 3, the coolant channel 56 defined by the inner surface 58 of the thermally conductive conduit 60 is depicting as following a generally straight path between the coolant inlet 52 and the coolant outlet 54 of the housing 48 and through the evaporation chamber 50. The pathway defined by the coolant channel 56 is not limited to the embodiments depicted in FIGS. 1 and 3. For example, in some embodiments, the pathway defined by the coolant channel 56 may coil-shaped or U-shaped. The pathway defined by the coolant channel 56 may extend through the evaporative cooling device 22 substantially horizontally, vertically, or a combination thereof.

In the evaporative cooling device 22, heat may be transferred from the coolant 30 flowing through the coolant channel 56 to the thermally conductive conduit 60 by convection, heat may be transferred through the thermally conductive conduit 60 by conduction, and heat may be transferred from the thermally conductive conduit 60 to the working fluid 29 by convection. Heat may be transferred from the coolant 30 to the working fluid 29 to help remove waste heat generated by the fuel cell 12 from the cooling system 10. When the working fluid 29 is applied to the outer surface 61 of the thermally conductive conduit 60, a temperature difference between the working fluid 29 and the coolant 30 flowing through the coolant channel 56 may drive sensible heat transfer between the working fluid 29 and the coolant 30 via convection, conduction, or a combination thereof. When the coolant 30 exhibits a relatively high temperature, as compared to the temperature of the working fluid 29, sensible heat transfer between the coolant 30 and the working fluid 29 may increase the temperature of the working fluid 29 and reduce the temperature of the coolant 30. The amount and rate of sensible heat transfer between the coolant 30 flowing through the coolant channel 56 and the working fluid 29 depends, at least in part, on the specific heat capacity of the working fluid 29, the temperature difference between the coolant 30 and the working fluid 29, and the mass flow rate of the coolant 30.

As the temperature of the working fluid 29 in the evaporative cooling device 22 increases and approaches or reaches the boiling point of the working fluid 29, latent heat transfer may occur from the coolant 30 to the working fluid 29, with at least a portion of the working fluid 29 undergoing a change in phase from a liquid to a gas. Latent heat transfer from the coolant 30 to the working fluid 29 may decrease the temperature of the coolant 30 without increasing the temperature of the working fluid 29. The amount of latent heat that can be transferred from the coolant 30 to the working fluid 29 depends on the amount of energy required to change the working fluid 29 from a liquid to a gas and on the mass of the working fluid 29 supplied to the evaporative cooling device 22. The amount of energy required to change the working fluid 29 from a liquid to a gas is known as the enthalpy of vaporization or the latent heat of fusion vaporization of the working fluid 29. The material properties and the mass of the working fluid 29 supplied to the evaporative cooling device 22 may be selected to provide the evaporative cooling device 22 with sufficient thermal energy storage capacity to compensate for the additional amount of waste heat generated by the fuel cell 12 during high load events, e.g., during take-off and climb.

Applying a working fluid 29 to the outer surface 61 of the thermally conductive conduit 60 during operation of the aircraft 2 may help maintain the coolant 30 (and the fuel cell 12) at a desirable operating temperature by removing excess waste heat therefrom, which may be desirable when the aircraft 2 is operating under high load conditions (e.g., during take-off and climb). In addition, because the amount of waste heat that can be removed from the cooling system 10 via evaporation of the working fluid 29 from the outer surface 61 of the thermally conductive conduit 60 is directly related to the latent heat of vaporization of the working fluid 29, this technique may help remove waste heat from the cooling system 10 without increasing the amount of drag experienced by the aircraft 2, which may increase the overall energy efficiency of the aircraft 2.

After the working fluid 29 has transitioned from a liquid to a gas, the evaporated working fluid 29 may be discharged from the evaporation chamber 50 of the evaporative cooling device 22, for example, via an opening 76 in the housing 48. In some embodiments, the opening 76 in the housing 48 may be in fluid communication with the vacuum pump and evacuation system 38. In some embodiments, the opening 76 in the housing 48 may be in fluid communication with a circumambient environment of the aircraft 2. In embodiments where the thermally conductive conduit 60 is at least partially submerged within a volume of the working fluid 29 contained in the evaporation chamber 50, the volume of the working fluid 29 in the evaporation chamber 50 may be sufficient to cover at least a portion of the thermally conductive conduit 60, without blocking the opening 76 in the housing 48 through which vapors of the working fluid 29 may be discharged or exhausted from the evaporation chamber 50.

The working fluid 29 may comprise a phase change material having a high latent heat of vaporization and the ability to undergo a phase change, i.e., from a liquid to a gas and vice versa, when subjected to certain temperature and pressure conditions generated within the evaporative cooling device 22. The working fluid 29 may be an aqueous or nonaqueous fluid. In some embodiments, the working fluid 29 may comprise or consist essentially of water, ethanol, propanol, methyl isobutyl ketone, or a combination thereof. In some embodiments, the working fluid 29 may have the same composition as that of the coolant 30. In some embodiments, the working fluid 29 may be selected or formulated to exhibit a relatively high vapor pressure at the temperature generated within the evaporative cooling device 22 during operation thereof, for example, to promote evaporation of the working fluid 29 from the outer surface 61 of the thermally conductive conduit 60 and discharge of the working fluid 29 from the evaporation chamber 50. In some embodiments, the working fluid 29 may be selected or formulated to promote evaporation of the working fluid 29 from the outer surface 61 of the thermally conductive conduit 60 and discharge of the working fluid 29 from the evaporation chamber 50 via the opening 76 in the housing 48 without use of the vacuum pump and evacuation system 38 or another mechanical device (e.g., a pump). In embodiments, the working fluid 29 may comprise one or more additives selected to impart certain desirable properties to the working fluid 29, e.g., a relatively high boiling point and/or a relatively low freezing point. Examples of additives include ethylene glycol and/or propylene glycol.

In embodiments where the composition of the working fluid 29 is the same as that of the coolant 30, the working fluid 29 and/or the working fluid reservoir 28 may be in fluid communication with the coolant header tank 16 and/or the coolant 30 circulating through the passageway defined by the coolant circuit 14.

In embodiments where the cooling system 10 includes the vacuum pump and evacuation system 38 coupled to the evaporative cooling device 22, the vacuum pump and evacuation system 38 may generate a subatmospheric pressure environment within the evaporation chamber 50, which may help promote evaporation of the working fluid 29 from the outer surface 61 of the thermally conductive conduit 60, even in situations where the temperature of the coolant 30 flowing through the coolant channel 56 is less than the boiling point of the working fluid 29 (if the working fluid 29 was at the same pressure as the coolant 30). The boiling point of the working fluid 29 is the temperature at which the vapor pressure of the working fluid 29 equals the circumambient pressure surrounding of the working fluid 29 and the working fluid 29 transitions from a liquid to a gas. The boiling point of the working fluid 29 depends on the circumambient pressure surrounding the working fluid 29. If the circumambient pressure is increased, the boiling point of the working fluid 29 will increase. On the other hand, if the circumambient pressure is decreased, the boiling point of the working fluid 29 will decrease. Therefore, the vacuum pump and evacuation system 38 may help promote evaporation of the working fluid 29 from the outer surface 61 of the thermally conductive conduit 60 by reducing the circumambient pressure within the evaporation chamber 50, which may reduce the temperature at which the working fluid 29 will transition from a liquid to a gas. Therefore, if the pressure inside the evaporation chamber 50 is less than the pressure in the passageway defined by the cooling circuit 14, the working fluid 29 may evaporate from the outer surface 61 of the thermally conductive conduit 60, even in situations where the temperature difference between the coolant 30 and the working fluid 29 would not be sufficient to evaporate the working fluid 29 if the coolant 56 and the working fluid 29 were at the same pressure.

In some embodiments, the vacuum pump and evacuation system 38 may be configured to evacuate a fluid including the evaporated working fluid 29 from the evacuation chamber 50 at a known flow rate, e.g., at a rate of about 100 liters per second. In some embodiments, the subatmospheric pressure environment generated in the evacuation chamber 50 may be in a range of about 5% to about 10% of atmospheric pressure (e.g., in a range of about 0.05 Atm to about 0.1 Atm).

In some embodiments, the opening 76 in the housing 48 may be in fluid communication with the inlet 40 and the outlet 42 of the plenum 18. In such case, flow rate of the airflow 44 through the plenum 18 may be sufficient to generate a relatively low pressure at the opening 76 in the housing 48 (as compared to the pressure within the evaporation chamber 50), which may promote release of vapors of the working fluid 29 from the evaporation chamber 50 via the opening 76 in the housing 48.

The fuel cell 12 includes an anode 62 and a cathode 64 separated by an ionically conductive electrolyte (not shown). The anode 62 is configured to receive a hydrogen-containing reactant gas 66 and to discharge a hydrogen-containing exhaust gas stream 68. The cathode 64 is configured to receive an oxygen-containing reactant gas 70 and to discharge a water vapor-containing exhaust gas stream 72. During operation of the fuel cell 12, hydrogen in the hydrogen-containing reactant gas 66 is oxidized at the anode 62, producing positively charged ions (e.g., hydrogen ions) and electrons. The positively charged hydrogen ions travel through the ionically conductive electrolyte from the anode 62 to the cathode 64, while the electrons simultaneously travel from the anode 62 to the cathode 64 outside the fuel cell 12 via an external circuit (not shown), which produces an electric current. The electric current generated during operation of the fuel cell 12 may be used to power the electric motor 4 onboard the aircraft 2. On the cathode 64 side of the fuel cell 12, The oxygen-containing reactant gas 70 is reduced by the electrons arriving from the external circuit and combined with the positively charged hydrogen ions to form water vapor, which is discharged from the fuel cell 12 in the form of the water vapor-containing exhaust gas stream 72. The reaction between oxygen and hydrogen at the cathode 64 is exothermic, which generates heat.

The fuel cell heat exchanger 24 is thermally coupled to the fuel cell 12 and is configured to transfer heat from the fuel cell 12 to the coolant 30 circulating through the passageway defined by the coolant circuit 14 during operation of the cooling system 10 to help maintain the fuel cell 12 within a desired operating temperature range.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cooling system for a fuel cell onboard a vehicle, the cooling system comprising:
a coolant circuit defining a coolant passageway, the coolant circuit being configured to circulate a coolant through the coolant passageway and through a portion of the fuel cell to absorb heat from the fuel cell; and
an evaporative cooling device including an evaporation chamber and a thermally conductive conduit extending through the evaporation chamber, the thermally conductive conduit having an inner surface and an opposite outer surface, the inner surface of the thermally conductive conduit at least partially defining a coolant channel in fluid communication with the coolant circulating through the coolant passageway, and the outer surface of the thermally conductive conduit being exposed to an environment within the evaporation chamber,
wherein, when a working fluid is applied to the outer surface of the thermally conductive conduit within the evaporation chamber, the evaporative cooling device is configured to evaporatively cool the coolant flowing through the coolant channel by promoting evaporation of the working fluid from the outer surface of the thermally conductive conduit.

2. The cooling system of claim 1, wherein the evaporation chamber is defined by a housing including an opening in fluid communication with a circumambient environment, and wherein the opening in the housing is configured to provide an outlet for gases including the working fluid to be discharged from the evaporation chamber.

3. The cooling system of claim 2, wherein the opening in the housing is in fluid communication with a circumambient environment of the vehicle.

4. The cooling system of claim 3, further comprising:
a plenum including an inlet and an outlet in fluid communication with the circumambient environment of the vehicle, wherein the inlet is configured to receive an airflow from the circumambient environment when the vehicle is moving, and wherein the opening in the housing is in fluid communication with the inlet and the outlet of the plenum.

5. The cooling system of claim 1, further comprising:
a vacuum pump and evacuation system configured to generate a subatmospheric pressure environment within the evaporation chamber.

6. The cooling system of claim 5, wherein the vacuum pump and evacuation system is configured to exhaust gases including the working fluid from the evaporation chamber to a circumambient environment of the vehicle.

7. The cooling system of claim 1, further comprising:
a volume of the working fluid contained within the evaporation chamber, wherein the outer surface of the thermally conductive conduit is at least partially submerged within the volume of the working fluid contained within the evaporation chamber.

8. The cooling system of claim 1, wherein a boiling point of the working fluid is less than that of the coolant circulating through the coolant passageway of the coolant circuit at the same pressure.

9. The cooling system of claim 1, wherein the working fluid comprises water, ethanol, or a combination thereof.

10. The cooling system of claim 1, wherein a vapor pressure of the working fluid is greater than the vapor pressure of water at the same temperature.

11. The cooling system of claim 1, further comprising:
a bypass operable to direct the coolant circulating through the coolant passageway to enter the evaporative cooling device or to bypass the evaporative cooling device.

12. The cooling system of claim 11, further comprising:
a controller configured to control operation of the bypass such that (i) coolant flows into the evaporative cooling device when the vehicle is operating under high load conditions, and (ii) coolant bypasses the evaporative cooling device when the vehicle is operating under low load conditions.

13. The cooling system of claim 12, further comprising:
a temperature sensor configured to sense a temperature of the coolant flowing through the coolant passageway defined by the coolant circuit and to communicate the temperature to the controller.

14. The cooling system of claim 13, wherein the controller is configured to control operation of the bypass such that (i) coolant flows into the evaporative cooling device when the temperature sensor indicates that the temperature of the coolant flowing through the coolant passageway is greater than a defined value, and (ii) coolant bypasses the evaporative cooling device when the temperature sensor indicates that the temperature of the coolant flowing through the coolant passageway is less than the defined value.

15. The cooling system of claim 1, further comprising:
a nozzle configured to apply droplets of a working fluid onto the outer surface of the thermally conductive conduit.

16. The cooling system of claim 1, further comprising:
a plenum including an inlet and an outlet in fluid communication with a circumambient environment of the vehicle, wherein the inlet is configured to receive an airflow from the circumambient environment; and
a heat exchanger in fluid communication with the inlet and the outlet of the plenum, wherein the heat exchanger is configured to transfer heat from the coolant circulating through the coolant passageway to the airflow flowing through the plenum.

17. The cooling system of claim 12, wherein the heat exchanger is disposed within the plenum.

18. The cooling system of claim 12, wherein the inlet of the plenum is configured to receive the airflow from the ambient environment when the vehicle is moving.

19. The cooling system of claim 1, wherein the fuel cell comprises:
an anode configured to receive a hydrogen-containing reactant gas and to discharge a hydrogen-containing exhaust gas stream; and
a cathode configured to receive an oxygen-containing reactant gas and to discharge a water vapor-containing exhaust gas stream.

20. The cooling system of claim 1, wherein the vehicle is an aircraft.
